(19) United States
(12) Patent Application Publication
(10) Pub. No.: US 2022/0006197 A1
(43) Pub. Date: Jan. 6, 2022

(54) Coupled-Feed Dipole Antenna

(71) Applicant: Innovation Sound Technology Co., LTD., Guangdong (CN)

(72) Inventors: Shun Ming YUEN, Guangdong (CN); Wai Yin MUNG, Guangdong (CN); Ka Ming WU, Guangdong (CN)

(21) Appl. No.: 16/631,035

(22) PCT Filed: Dec. 6, 2018
(86) PCT No.: PCT/CN2018/119460

§ 371 Date: Jan. 14, 2020

(30) Foreign Application Priority Data
Dec. 3, 2018 (CN) 201822007695.2

(51) Int. Cl. H01Q 9/16; H01Q 1/48

(52) U.S. Cl. CPC H01Q 9/16; H01Q 1/48

(57) ABSTRACT

The utility model discloses a coupled-feed dipole antenna, which comprises a PCB, a metal patch, an LTCC antenna, and a transmission line. The said LTCC antenna and the transmission line are disposed on the bottom of the PCB, the ground plane is disposed on the top surface of the PCB, the LTCC antenna is connected to the transmission line, and the signal input is transmitted to the antenna through the transmission line. The said metal patch is disposed on the top surface of the PCB, and fixed to the LTCC antenna by soldering. The utility model sets the LTCC antenna and the metal patch together, turning the original monopole antenna into a coupled-feed dipole antenna. By setting the size of a patch (metal sheet), the antenna resonance working frequency can be lowered to a low frequency without increasing the antenna length.

### FIELD OF THE INVENTION

The utility model relates to a novel dipole antenna, in particular to a coupled-feed dipole antenna.

### BACKGROUND OF THE INVENTION

Dipole antennas are the simplest type of antenna in wireless applications. A dipole consists of two identical conductive components into which RF current flows. The current causes signal radiation through the dipole. Theoretically, the dipole length must be half wavelength (0.5λ) to obtain the maximum response. The half-wavelength corresponds to approximately 6 cm (in the air) in the 2.4 GHz ISM band. In the antenna as shown in FIG. 1, the ground plane acts as a good radiator, which facilitates the antenna length to change into one-quarter wavelength. However, the location and size of the ground plane are very important in the design. Since the current in a reflected image has the same direction and phase as the current in a real antenna, when the ground plane is infinite in area or its size is much larger than the half-wavelength itself, the one-quarter wave plus the image forms a half-wave dipole.

There are many antenna solutions with different sizes available on the market, and different antenna lengths represent different operating frequencies. Generally, simple antenna structures such as monopole antennas are used. They need a ground plane for reflection, and thus become dipole antennas.

There are many existing downsizing solutions on the market, which are especially employed in the 2.4 GHz ISM band for Bluetooth communications. One common type is low temperature co-fired ceramic (LTCC) antennas, which come in different sizes and lengths, such as 7 mm, 5 mm, and 3 mm in length. Different sizes correspond to different operating frequencies depending on their length.

FIG. 1 presents a diagram of a 3 mm-long LTCC antenna (monopole antenna), usually used in the 2.4 GHz ISM band for Bluetooth communications. FIG. 2 shows the S-parameter (S₁₁) result of the antenna input in FIG. 1, which represents the antenna's resonance working frequency. The antenna results in poor overall performance because its resonance frequency is higher than the operating frequency. Hence, a matching circuit is required to restore the correct resonance frequency, as shown in FIG. 3. The matching circuit is used for maximum power transmission from the transceiver to the antenna. However, the antenna is still inefficient, and causes additional cost and circuit area.

Content of Utility Model

The present utility model aims to provide a coupled-feed dipole antenna, so as to solve the problems presented in the Background of the Invention above.

To achieve the above goal, the utility model provides the following technical proposals: A coupled-feed dipole antenna comprises a ground plane, a metal patch, an LTCC antenna, and a transmission line. The said LTCC antenna and the transmission line are disposed on the bottom of the PCB, the ground plane is disposed on the top surface of the PCB, the LTCC antenna is connected to the transmission line, and the signal input is transmitted to the antenna through the transmission line. The said metal patch is disposed on the top surface of the PCB, and fixed to the LTCC antenna by soldering.

As a further proposal of the present utility model, a matching circuit is further connected between the LTCC antenna and the transmission line.

As a further proposal of the present utility model, a circuit is disposed at the bottom of the ground plane.

As a further proposal of the present utility model, the working frequency of the antenna is adjusted by the size of the metal patch.

As a further proposal of the present utility model, the working frequency of the antenna is adjusted by the length of the LTCC antenna.

Compared with the prior art, the beneficial effects of the present utility model are as follows:

1. The LTCC antenna and the metal patch are set together, which turns the original monopole antenna into a coupled-feed dipole antenna;

2. By setting a patch (metal sheet), the antenna resonance working frequency can be lowered to a low frequency without increasing the antenna length.

### BRIEF INTRODUCTION OF DRAWINGS

FIG. 1 is a schematic structural diagram of the current LTCC antenna.

FIG. 2 is a graph showing the S-parameter (S₁₁) result of the current LTCC antenna.

FIG. 3 is a schematic structural diagram of the current LTCC antenna connected to the matching circuit.

FIG. 4 is a schematic top view of the coupled-feed dipole antenna in the utility model.

FIG. 5 is a schematic structural front view of the coupled-feed dipole antenna in the utility model.

FIG. 6 is a graph showing the S-parameter (S₁₁) result of the coupled-feed dipole antenna in the utility model.

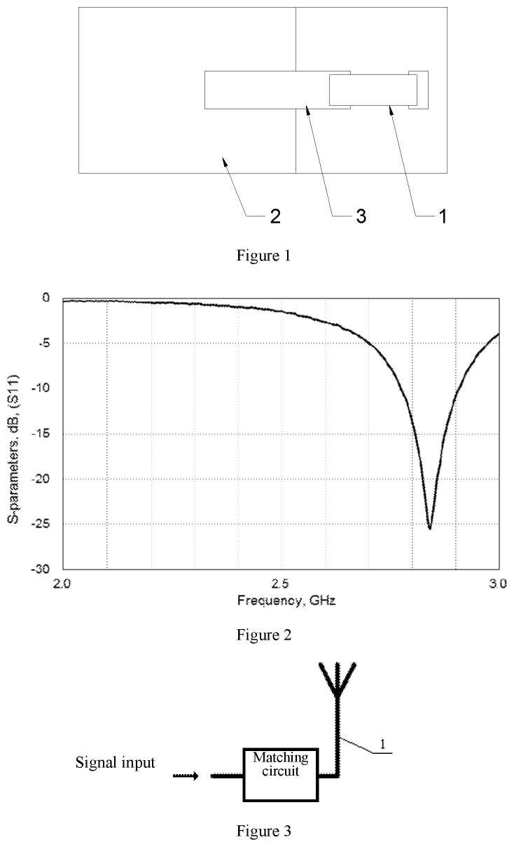

### DETAILED DESCRIPTION OF THE PREFERRED EMBODIMENTS

The technical proposals in the embodiments of the utility model will be clearly and completely described as follows with reference to the drawings in the embodiment of the utility model. Obviously, the described embodiments are only a part of that in the present utility model, rather than all the embodiments. Based on the embodiment in the present utility model, all other embodiments obtained by those having ordinary skill in the art without making any creative work belong to the protection scope of the present utility model.

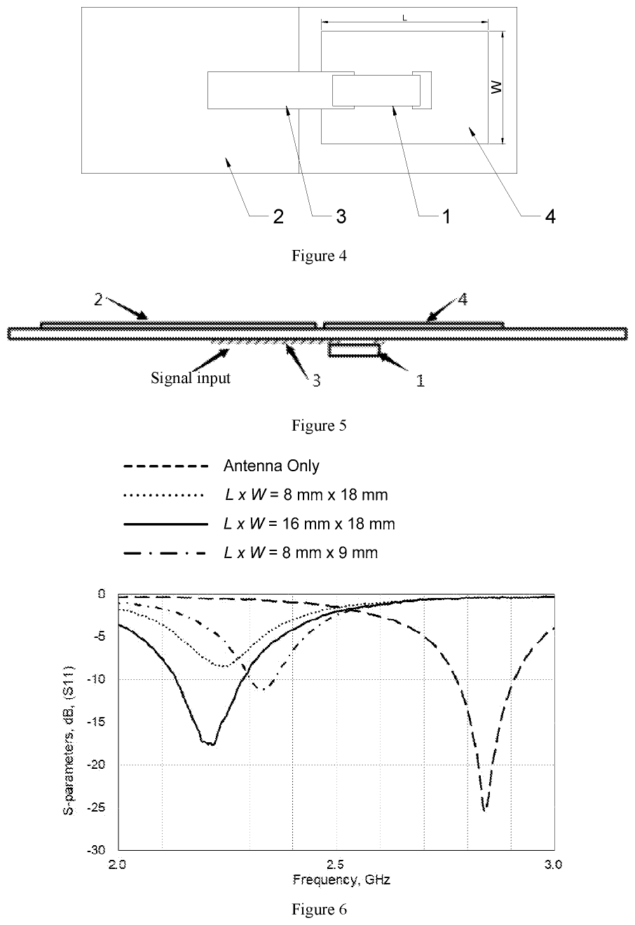

With reference to FIGS. 4 to 5, the embodiment in the present utility model provides a coupled-feed dipole antenna comprising a ground plane 2, a metal patch 4, an LTCC antenna (1) and a transmission line (3). The said LTCC antenna (1) and the transmission line (3) are disposed on the bottom of the PCB, the ground plane (2) is disposed on the top surface of the PCB, a circuit is disposed on the bottom of the ground plane (2), the LTCC antenna (1) is connected to the transmission line (3), and the signal input is transmitted to the antenna through the transmission line (3). The said metal patch (4) is disposed on the top surface of the ground plane (2), and fixed to the LTCC antenna (1) by soldering to form a coupled-feed dipole antenna.

Assuming that the width and length of the metal patch (4) are W*L respectively, FIG. 6 illustrates the S-parameter (S₁₁) of a coupled-feed dipole antenna, and its resonance operating frequency, under different W and L sizes. It can be seen that the resonance frequency of an antenna varies greatly depending on the size of the metal patch (4). It is indicated that by changing the size of the patch, the resonance frequency is reduced and adjusted to a low frequency without lengthening the size of the LTCC antenna (1) itself.

A matching circuit is also disposed between the LTCC antenna (1) and the transmission line (3) to make the antenna reach the maximum transmission power. The working frequency of the antenna may be adjusted by the size of the metal patch (4), and also by the length of the LTCC antenna (1), as well as the size of the metal patch (4).

For those skilled in the art, apparently the present utility model is not limited to the details given in the above exemplary embodiments. The present utility model can be embodied in other specific forms without departing from the spirit or essential characteristics of the utility model. Therefore, the embodiments shall be considered as exemplary and unrestricted in any way. The scope of the utility model is defined by the appended claims rather than the above description. Hence, all changes intended to come within the meaning and range of equivalent elements of the claims shall be included within the utility model. Any marks on drawings to the Claims shall not be construed as limiting the Claims involved.

Furthermore, it shall be understood that although the Specification is described in terms of embodiments, not every embodiment includes only one independent technical scheme. The description style in the Specification is for clarity only. Those skilled in the art shall take the Specification as a whole. The technical schemes in various embodiments may also be combined as appropriate to form other embodiments that can be understood by those skilled in the art.

1. A coupled-feed dipole antenna is characterized by comprising a ground plane, a metal patch, an LTCC antenna, and a transmission line. The LTCC antenna and the a transmission line are disposed on the bottom of the PCB, a ground plane is disposed on the top surface of the PCB, the LTCC antenna is connected to the transmission line, and the signal input is transmitted to the antenna through the transmission line. The metal patch is disposed on the top surface of the ground plane, and fixed to the LTCC antenna by soldering.

2. A coupled-feed dipole antenna according to claim 1, wherein a matching circuit is further connected between the LTCC antenna and the transmission line.

3. A coupled-feed dipole antenna according to claim 1, wherein a circuit is disposed at the bottom of the ground plane.

4. A coupled-feed dipole antenna according to claim 1, wherein the working frequency of the antenna is adjusted by the size of the metal patch.

5. A coupled-feed dipole antenna according to claim 1, wherein the working frequency of the antenna is adjusted by the length of the LTCC antenna.
